(19) United States
(12) Patent Application Publication
(10) Pub. No.: US 2019/0232704 A1
(43) Pub. Date: Aug. 1, 2019

(54) STRUCTURAL UNDERBLANKET UNIT FOR BLANKET CYLINDERS OF PRINTING MACHINES AND PROCESS FOR ADJUSTING A DISTANCE OF A BLANKET FROM A WALL OF A BLANKET CYLINDER

(71) Applicant: PAVAN FORNITURE GRAFICHE S.P.A., DOSSOBUONO DI VILLAFRANCA (IT)

(72) Inventor: Luca PAVAN, DOSSOBUONO DI VILLAFRANCA (IT)

(21) Appl. No.: 16/262,873

(22) Filed: Jan. 30, 2019

(30) Foreign Application Priority Data
Jan. 31, 2018 (IT) 102018000002259

(51) Int. Cl. B41N 10/04; B41F 3/56

(52) U.S. Cl. CPC B41N 10/04; B41N 2210/04; B41F 3/56

(57) ABSTRACT

A structural underblanket unit (10) for blanket cylinders (100) of printing machines, comprising a first layer (11) made of rubber, a second layer (12) made of polyester and a third layer (13) made of fabric. The layers (11, 12, 13) are solidly bonded to one another so as to define a multilayer structural unit (10) having an overall transversal thickness (S) corresponding to the sum of the transversal thicknesses (S11, S12, S13) of said layers, the order of bonding of said layers being any whatsoever. A process for adjusting a distance of a printing blanket (101) from a wall (102) of a blanket cylinder of a printing machine.

### CROSS-REFERENCE TO RELATED APPLICATION

The present application claims the benefit of Italian Patent Application No. 102018000002259, filed on Jan. 31, 2018, and titled “STRUCTURAL UNDERBLANKET UNIT FOR BLANKET CYLINDERS OF PRINTING MACHINES AND PROCESS FOR ADJUSTING A DISTANCE OF A BLANKET FROM A WALL OF A BLANKET CYLINDER,” the disclosure of which are expressly incorporated by reference herein in its entirety.

### TECHNICAL FIELD

The present disclosure relates to a structural underblanket unit for blanket cylinders of printing machines and falls within the sector of consumable spare parts, in particular for printing machines of the offset type. The present disclosure further regards a process for adjusting the distance of a printing blanket from a wall of a respective blanket cylinder of a printing machine.

### BACKGROUND

Offset printing is an indirect printing process that is based on the phenomenon of chemical/physical repulsion between water (e.g., for an aluminum plate, which is hydrophilic) and greasy substances (e.g., for the lipophilic graphics present on the same, which attract the greasy binder constituting the ink).

It is an indirect printing process, because printing does not take place by directly transferring the ink from the printing plate to the print media, but rather by transferring the ink from the plate to an intermediate rubber sheet, commonly called a “printing blanket” or also simply a “blanket.” The blanket has an outer layer that is generally made of rubber and is suitable for receiving the ink from the printing plate and transferring it to the print media. In other words, the printing plate does not come into direct contact with the media to be printed.

Offset printing takes place using three cylinders in contact with one another. In particular, the main components of an offset printing machine can be thus identified:

(1) a “sheet feeder” device that introduces the sheet to be printed (generally made of paper, cardboard or synthetic printing materials, or tinplate) into the machine, in the case of so-called “sheet-fed” machines; or else

(2) a device called a “paper unwinder” in reel-fed machines, or so-called “web offset” machines.

Then, in every printing section, there is:

(1) a set of ink grinding rollers and printing plate inkers;

(2) a plate (or printing plate) cylinder;

(3) a blanket cylinder;

(4) a counter-pressure cylinder opposite the blanket cylinder and adapted to provide a sufficient pressure based on the thickness of the printing medium.

In greater detail, the plate transfers the images onto the printing surface of the blanket. The printing surface of the blanket receives the inked image already processed on the plate. The image is processed on the plate, for example, by the water/ink emulsion. A print of the may be transferred onto the medium to be printed as a result of printing pressure exerted by the counter-pressure cylinder.

To ensure that the printing takes place correctly, the tangential speed of the (e.g., outer) printing surface of the blanket on the blanket cylinder is specified identical to the tangential speed of the printing plate on the plate cylinder.

Given that blankets of different thickness exist, it is possible that the tangential speed of the printing surface of the blanket is different from the speed when the blanket is positioned on the respective blanket cylinder.

In accordance with the prior art, it is known to compensate for the variation in tangential speed by introducing a spacer of calibrated thickness. The spacer of calibrated thickness is commonly called a pack, which is positioned underneath the blanket and is thus interposed between the wall of the blanket cylinder and the blanket itself. In other words, the presence of the pack enables the radius up to the printing surface of the blanket to be varied when it is wrapped over the blanket cylinder. In still other words, the insertion of the pack enables the distance between the printing surface of the blanket and the rotation axis of the cylinder to be adjusted so as to obtain a desired tangential speed.

According to the prior art, the pack is composed of a rubber sheet and one or more calibrated cardboard sheets resting on top of it. In particular, the whole is formed into a “pack” between the back of the blanket and the wall of the blanket cylinder.

Generally, the overall thickness of the pack ranges from about 0.1 mm to as much as about 1.45 mm thus making it possible to vary the entity of the “final” radius of the blanket cylinder. For example, the final radius is measured starting from the rotation axis of the cylinder and up to the level of the (e.g., outer) printing surface of the blanket.

This type of pack, despite being relatively economical, has major drawbacks.

First of all, the cardboard sheets deteriorate in a short time. In fact, due to the pressures typical of the printing process, the cardboard sheets tends to become flattened, losing the ability to compensate for variations in the thickness of the blanket for which they are used. Furthermore, the cardboard sheet gets wet, both because of the periodic process of washing the blanket, and because of the wetting of the printing plate necessary to carry out the printing process. As can be understood, the deterioration of the cardboard sheet is very disadvantageous, because it obliges the operator to halt the operation of the machine in order to replace the cardboard sheet, with results in disadvantageous consequences in terms of machine productivity.

Secondly, when the thickness to be compensated for is great, typically over 1.2 mm, use is made of various cardboard sheets, positioned one on top of the other. In fact, in order to be able to have a sufficient range of thicknesses, even minimal, the cardboard sheets are generally produced and sold with very small thicknesses. In this way, in fact, it is possible to have cardboard sheets both for minimal compensations, and for substantial compensations (e.g., in the latter case it being sufficient, precisely, to position several cardboard sheets on top of one another). Disadvantageously, positioning several cardboard sheets on top of one another means adding together the dimensional tolerances of the individual cardboard sheets and thus increasing the overall dimensional imprecision of the pack. In fact, the “nominal” thickness of the cardboard sheet does not generally correspond to the “real” thickness thereof and therefore overlaying several cardboard sheet reveals to be detrimental for the correct calibration of the printing process.

A further disadvantage is a pack obtained by overlaying a rubber sheet and one or more cardboard sheets results in a reciprocal sliding between the individual components. Reciprocal sliding occurs because the rubber sheet and the cardboard sheets are maintained in a reciprocal position because of the fact of being interposed between the blanket and the wall of the blanket cylinder. Disadvantageously, due to the strong mechanical stresses of the printing process and given the freedom of sliding between the rubber sheet and the cardboard sheets and between the cardboard sheets themselves, improper positioning of the pack can occur, with consequent imprecision on the surface of the blanket, which compromises the final quality of the printing process.

### SUMMARY

One aspect of the present disclosure provides a structural under packing, or “underblanket”, unit for blanket cylinders of printing machines that is durable. That is, the structural under packing is capable of remaining stable and unaltered for a long period of time.

Another aspect of the present disclosure is to provide a structural underblanket unit that enables easy, precise setting of the radius of the blanket cylinder.

A further aspect of the present disclosure is to propose a structural underblanket unit that is easy to manipulate and easy to install.

Another aspect of the present disclosure is to provide a process for adjusting a distance of a blanket from a wall of a blanket cylinder of a printing machine.

The configurations of the present disclosure achieve these and other aspects by providing a structural underblanket unit composed of three layers, or sheets, each having a predefined transversal thickness. The structural underblanket is composed of: a first layer made of rubber, a second layer made of polyester and a third layer made of fabric. The layers are solidly bonded to one another so as to define a multilayer structural unit, or “pack”, and configured so as to have an overall transversal thickness corresponding to the sum of the transversal thicknesses of the individual layers.

In accordance with one aspect of the present disclosure, the order of bonding of the layers is any whatsoever (e.g., the layers can be overlaid according to any sequence). In other words, the multilayer structural unit (or pack) according to the present disclosure is produced in a single body. Furthermore, it should be noted that the structural unit thus defined has no printing blanket. In this configuration, the structural unit so it is configured distinct and independently removable from a corresponding blanket with which it is adapted, in use, to collaborate. In still other words, the structural underblanket unit according to the present disclosure is a component that is independent from the blanket and as such can be transported, moved, manipulated and/or replaced independently of the blanket itself. Advantageously, the pack according to the present disclosure is extremely durable, lasting even up to twenty times longer than packs made in accordance with the prior art.

In a further advantageous manner, the pack according to the present disclosure has high operating reliability, given that the layers, being solidly bonded to one another, do not undergo any reciprocal sliding. In this manner, the structural unit remains correctly positioned underneath the blanket, contributing to increasing the quality and precision of the printing process.

The second layer made of polyester may be interposed between the first layer made of rubber and the third layer made of fabric and is bonded to them. Advantageously, the marked physiochemical affinity between polyester and fabric, on one hand, and between polyester and rubber, on the other, lends the pack high stability and durability. The second layer made of polyester, being bonded to the first layer made of rubber and the third layer made of fabric, defines respective connection interfaces which are extremely robust and not subject to phenomena of delamination. In this manner, the structural unit according to the present disclosure exhibits high resistance both to the mechanical stresses typical of the printing process and to the infiltrations consequent upon the washing and wetting processes.

In a further advantageous manner, the fabric layer is able, when necessary, to lend the structural unit a great thickness as desired, and thus makes it possible to broaden the range of use of the pack. In addition, the rubber and polyester layers collaborate both to lend the structural unit adequate softness to facilitate the penetration of ink into the interstices of the printing media and to maintain the thickness over time. In particular, polyester, in addition to being extremely durable in terms of retaining its thickness, strongly limits the structural deformations of the pack during the operation of the blanket cylinder, thus ensuring that a high dimensional precision of the entire structural unit is maintained.

In accordance with one aspect of the present disclosure, the first layer made of rubber is configured to rest upon a bottom surface, or back, of the blanket, whilst the third layer made of fabric is configured to rest upon a wall of a blanket cylinder, in such a way that the structural unit, in use, is interposed between the blanket and the wall of the cylinder.

In this manner, the structural underblanket unit according to the present disclosure is advantageously and easily simple to manipulate and interchangeable. Furthermore, its interposition between the blanket and the blanket cylinder does not entail the use of glue or techniques similar to gluing. Advantageously, the mechanical interaction that is established between the blanket, structural unit and blanket cylinder prevents their reciprocal slipping during the printing phase.

According to one aspect of the present disclosure, the value of the overall transversal thickness of the structural unit (pack) may be between about 0.55 mm and about 1.50 mm. In accordance with alternative variant configurations, the transversal thickness of the pack can have values up to 2 mm or higher.

According to a further aspect of the present disclosure, the value of the transversal thickness of the first layer made of rubber is greater than about 0.1 mm.

The value of the transversal thickness of the second layer made of polyester may be greater than about 0.1 mm.

In accordance with a further aspect of the present disclosure, the value of the transversal thickness of the third layer made of fabric is greater than about 0.15 mm.

The term fabric, in accordance with the present disclosure, means a layer obtained by weaving, i.e. by weaving warp threads with weft threads. In accordance with the present disclosure, the material of the threads could be any whatsoever and may be selected from among cotton, synthetic material (e.g. nylon) or a cotton and synthetic blend.

In general, the values of transversal thickness have a tolerance of ±0.02 mm relative to a nominal value.

The present disclosure achieves the specified aspects and pursues further ones, also providing a process for adjusting a distance of a blanket from a wall of a blanket cylinder of a printing machine. In particular, this process enables an adjustment of the radial distance of the printing surface of the blanket from a wall of the cylinder itself, where the expression “radial distance” means the distance of said printing surface of the blanket measured along a radius of a cross section of the blanket cylinder.

A process, according to one aspect of the present disclosure includes the steps of:

(1) preparing a first layer made of rubber and having a predefined transversal thickness;

(2) preparing a second layer made of polyester and having a predefined transversal thickness;

(3) preparing a third layer made of a fabric and having a predefined transversal thickness;

(4) solidly bonding the layers to one another according to any order whatsoever, so as to obtain a multilayer structural unit, or pack, having an overall transversal thickness corresponding to the sum of the transversal thicknesses of said layers;

(5) placing the structural unit between the blanket and the wall of the blanket cylinder.

Advantageously, the process enables the radial distance to be adjusted in a rapid and long-lasting manner, given the high precision and dimensional stability of the structural unit. In a further advantageous manner, the adjustment process enables pack replacement interventions to be deferred over time, with beneficial effects on the productivity of the printing machine.

In accordance with one aspect of the present disclosure, the second layer made of polyester is bonded to the remaining first and second layers in such a way as to be interposed between them.

### DESCRIPTION OF THE DRAWINGS

Additional features and advantages of the present disclosure will emerge more clearly from the indicative, and hence non-limiting, description of one or more configurations of the present disclosure, as illustrated in the appended drawings.

FIG. 1 illustrates a perspective view of a structural unit according to the present disclosure.

FIG. 2 illustrates a sectional view of a blanket cylinder provided with the structural unit shown in FIG. 1.

It should be understood that the drawings serve solely to clarify, in combination with the description, the inventive principles at the basis of the present disclosure.

### DETAILED DESCRIPTION

In the present description, the reference to “one configuration” or similar expressions means that a particular feature, structure or characteristic described in connection with the configuration is included in at least one configuration of the present description. Appearances of the phrases “in one configuration”, and similar expressions may, albeit not necessarily, all refer to the same configuration. Analogously, the use of the term “implementation” indicates an implementation having a particular feature, structure or characteristic described in connection with one or more configurations of the present description; in the absence, however, of an explicit correlation indicating otherwise, an implementation can be associated with one or more configurations.

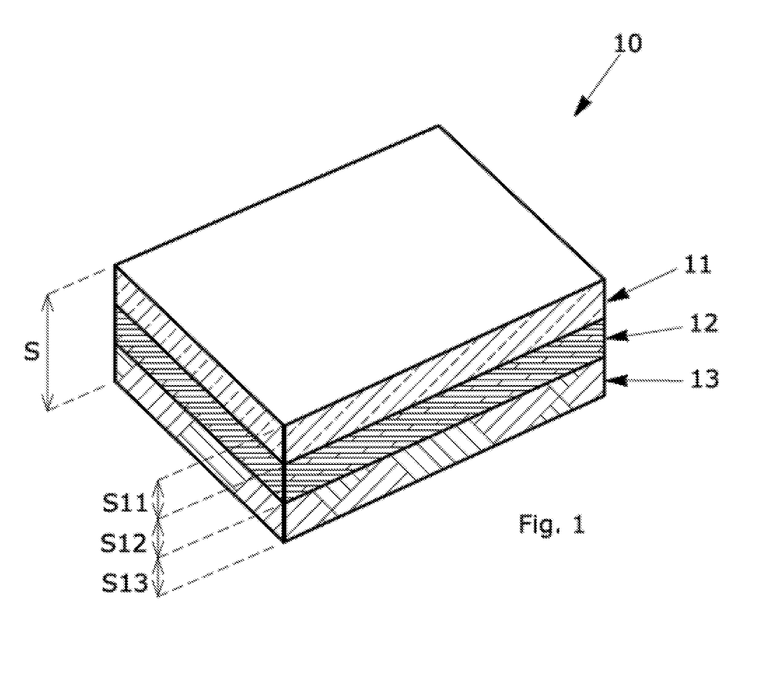

With particular reference to FIG. 1, a structural unit, or pack, has been denoted in its entirety by the number 10.

The pack 10 is composed of a first layer 11 made of rubber, which may be nitrile rubber, also known as Buna-N or Perbunan. Furthermore, the rubber may have a “shore A” hardness between 71 and 77. The pack 10 is further composed of a second layer 12 made of polyester and a third layer 13 made of fabric.

The layers 11, 12, 13 are solidly bonded to one another, so that the pack 10 is multilayer and has an overall transversal thickness S corresponding to the sum of the transversal thicknesses S11, S12, S13 of the aforesaid layers 11, 12, 13. In other words, the layers 11, 12, 13 are bonded to one another in such a way as to define a single multilayer body, i.e. the above-mentioned pack 10.

The second layer 12 made of polyester is interposed between the first layer 11 made of rubber and the third layer 13 made of fabric and is bonded to them. Advantageously, the polyester layer 12, being an intermediate layer, acts as a connecting interface, as it has physiochemical characteristics making it easily connectable both to the first layer 11 made of rubber and the third layer 13 made of fabric.

In accordance with further unillustrated variant configurations, there is envisaged the possibility that the layers are bonded together according to an order different from the one illustrated in FIG. 1; for example, the fabric layer could be interposed between the rubber layer and the polyester layer. In this case, the polyester layer is configured to rest upon the wall of the blanket cylinder. Other combinations of layers are clearly possible without going beyond the inventive concept of the present disclosure.

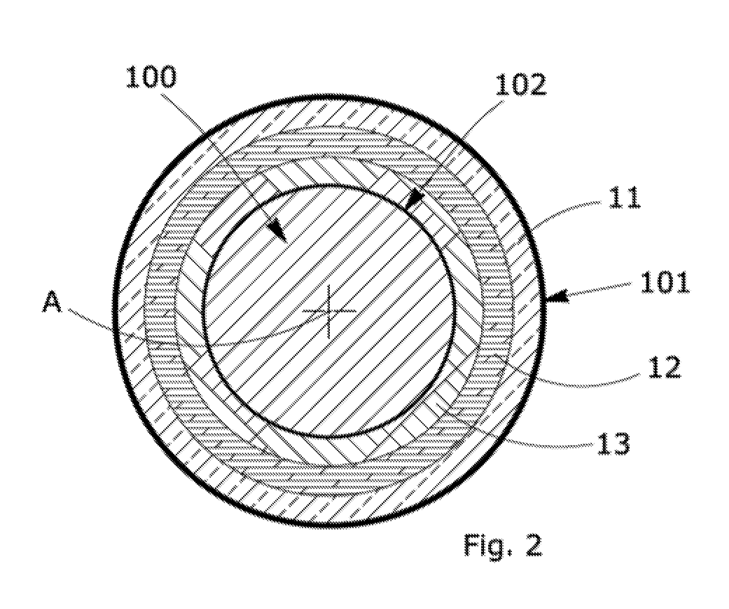

With particular reference to FIG. 2, the first layer 11 made of rubber is configured to rest upon a bottom surface of a blanket 101, whereas the third layer 13 made of fabric is configured to rest upon a wall 102 of a blanket cylinder 100, so that the pack 10 is interposed, in use, between the blanket 101 and the wall 102 of the cylinder.

The blanket cylinder 100 rotates about an axis A according to known methods not further described.

The fabric used to make the third layer is selected from among cotton, a synthetic material (e.g. nylon) or a cotton and synthetic blend.

According to a one aspect, the pack 10 has an overall transversal thickness S between about 0.55 mm and about 1.45 mm. In accordance with alternative variant configurations, the transversal thickness of the pack can have values up to 2 mm or higher.

According to a possible implementation, the value of the transversal thickness S11 of the first layer 11 made of rubber is greater than about 0.1 mm and may be between about 0.12 and about 0.72 mm.

In accordance with a further implementation, the second layer 12 made of polyester has a transversal thickness S12 greater than about 0.1 mm and may be between about 0.19 and about 0.35 mm.

According to another implementation, the value of the transversal thickness of the third layer 13 made of fabric is greater than about 0.15 mm and may be between about 0.2 and about 0.4 mm.

For each of the above transversal thicknesses S, S11, S12, S13, there is envisaged a tolerance of ±0.02 mm relative to a nominal value.

A possible method for producing the pack 10 (FIG. 1) may include the following steps:

(1) preparing a first layer made of rubber;

(2) preparing a second layer made of polyester, for example, having a Trichloroacetic Acid (TCA) treatment on at least one of its surfaces, so as to facilitate adhesion with the rubber layer;

(3) preparing a third layer made of fabric;

(4) bonding the fabric layer to the polyester layer, for example by gluing or knitting;

(5) heating the rubber layer;

(6) applying the rubber layer on top of the polyester layer.

In accordance with an alternative implementation of the production method, it is envisaged that the order of execution of the steps of heating the rubber layer and applying it on the polyester layer is inverted, that is, first the rubber layer is applied on the polyester and then it is heated. The heating may take place with the passage of air or by irradiation with infrared radiation.

According to a variant of implementation of the production method, there is envisaged the possibility that the order of bonding the layers is any whatsoever. In this case, for example, it is envisaged that the rubber layer is applied on the fabric layer, after the latter was previously bonded to the polyester, for example by gluing or knitting. In this case, the fabric layer is interposed between the rubber layer and the polyester layer, the latter thus being configured to rest upon the wall of the blanket cylinder.

With particular reference to FIG. 2, a process for adjusting a distance of a printing blanket from a wall of a blanket cylinder of a printing machine will now be described.

In particular, the process relates to an offset printing machine provided with a so-called blanket cylinder provided with a blanket, generally made of rubber or other materials suitable for the printing process.

The process may include the steps of:

i) preparing a first layer 11 made of rubber and having a predefined transversal thickness S11;

ii) preparing a second layer 12 made of polyester and having a predefined transversal thickness S12;

iii) preparing a third layer 13 made of a fabric and having a transversal predefined thickness S13;

iv) solidly bonding said layers 11, 12, 13 to one another according to any order whatsoever in order to obtain a multilayer structural unit 10 having an overall transversal thickness S corresponding to the sum of the transversal thicknesses S11, S12, S13 of said layers;

v) placing the structural unit 10 between the blanket 101 and the wall 102 of the blanket cylinder 100.

The second layer 12 made of polyester may be bonded to the remaining first and second layers 11, 13 in such a way as to be interposed between them.

In other words, the structural unit 10 is made in a single body and is interposed between the blanket 101 and the wall 102 of the blanket cylinder 100. In this manner, the structural unit 10 is easily removable from its positioning in order to be replaced in the event of wear or in the event that the thickness to be interposed between the blanket 101 and the blanket cylinder 100 is changed.

Any modifications or variants which, in the light of the description, are evident to the person skilled in the art, are considered to fall within the scope of protection established by the present disclosure, according to considerations of technical equivalence.

What is claimed is:

1. A structural underblanket unit (10) for blanket cylinders (100) of printing machines, comprising:
a first layer (11) made of rubber and having a predefined transversal thickness (S11);
a second layer (12) made of polyester and having a predefined transversal thickness (S12);
a third layer (13) made of fabric and having a predefined transversal thickness (S13), said layers (11, 12, 13) being solidly bonded to one another so as to define a multilayer structural unit (10) having an overall transversal thickness (S) corresponding to the sum of the transversal thicknesses (S11, S12, S13) of said layers, the order of bonding of said layers being any whatsoever, wherein said structural unit (10) has no printing blanket, and configured distinct and independently removable from a corresponding blanket with which, in use, it is adapted to collaborate.

2. The structural unit according to claim 1, wherein the second layer (12) made of polyester is interposed between and bonded to said first (11) and third (13) layers.

3. The structural unit (10) according to claim 2, wherein the first layer (11) made of rubber is configured to rest upon a bottom surface of a printing blanket (101), whilst the third layer (13) made of fabric is configured to rest upon a wall (102) of a blanket cylinder, in such a way that said structural unit (10), in use, is interposed between the printing blanket (101) and the wall (102) of the cylinder.

4. The structural unit (10) according to claim 1, wherein the value of the overall transversal thickness (S) of the structural unit (10) may be between about 0.55 mm [millimeters] and about 1.45 millimeters.

5. The structural unit (10) according to claim 1, wherein the value of the transversal thickness (S11) of the first layer (11) made of rubber is greater than about 0.1 mm [millimeters].

6. The structural unit (10) according to claim 1, wherein the value of the transversal thickness (S12) of the second layer (12) made of polyester is greater than about 0.1 millimeters.

7. The structural unit (10) according to claim 1, wherein the value of the transversal thickness (S13) of the third layer (13) made of fabric is greater than about 0.15 millimeters.

8. The structural unit (10) according to claim 1, wherein each of the transversal thicknesses has a tolerance of ±0.02 millimeters relative to a nominal value.

9. A process for adjusting a distance of a printing blanket (101) from a wall (102) of a blanket cylinder of a printing machine, comprising the steps of:
preparing a structural unit (10) according to claim 1;
placing the structural unit (10) between the printing blanket (101) and the wall (102) of the blanket cylinder.

10. The process according to claim 9, further comprising the following steps:
preparing a structural unit (10) according to claim 2;
applying the first layer made of rubber to a bottom surface, or back, of the printing blanket;
applying the third layer made of fabric on a wall of a blanket cylinder.

11. A printing machine comprising a blanket cylinder provided with a blanket, wherein the structural unit according to claim 1 is interposed between the blanket and a wall of the blanket cylinder.
